(19) United States
(12) Patent Application Publication
(10) Pub. No.: US 2008/0109856 A1
(43) Pub. Date: May 8, 2008

(54) System and method for content planning in electronic displays

(76) Inventor: Graham N. Beland, Hyde Park, UT (US)

Correspondence Address: TRASK BRITT, P.O. BOX 2550, SALT LAKE CITY, UT, 84110, US

(21) Appl. No.: 11/585,684

(22) Filed: Oct. 24, 2006

(51) Int. Cl. H04N 7/173

(52) U.S. Cl. 725/86

(57) ABSTRACT

Methods, systems, and computer readable media are disclosed for presenting media content, which may include visual content and audio content, on a display network. A computing server and a plurality of electronic displays at a variety of display locations and in communication with the computing server are provided. A plurality of media contents may be communicated to the computing server. The media content may also be communicated from the server to one or more of the electronic displays. A user is enabled to access a graphical user interface on the computing server to view and plan a schedule of times for at least one visual content of the plurality on at least one electronic display of the plurality. The method also includes displaying the at least one visual content on the at least one electronic display at the schedule of times.

### BACKGROUND OF THE INVENTION

1. Field of the Invention

The present invention relates generally to displaying images, and more specifically, to displaying images on electronic display boards and electronic billboards.

2. State of the Art

Billboards and large signs have been used for many years to convey information to a passersby such as advertising, traffic messages, and the like. Traditionally these signs and billboards were only capable of delivering a single message or advertisement. This message was generally printed on strips of paper that were then adhered to the billboard. To change the message, new paper needed to be printed and adhered to the billboard.

More recently, display boards and billboards have become electronic, using lights, light emitting diodes (LEDS), and other electronic devices to display visual content that can be easily adaptable to display a wide variety of messages in the form of words and images from the same sign without having to physically change the characteristics of the sign. These electronic boards can easily modify a graphic image or message to create video displays and modify the type of message or advertisement that is shown on the electronic board at regular intervals, or at targeted times depending on expected traffic near the sign, or public interest. These possible images are generally referred to herein as visual content.

For conventional billboards, the visual content is delivered to the physical location and affixed to the billboard. With electronic displays, the visual content must still be delivered to the physical location, but the content delivery may be performed electronically. In addition, while traditional billboards may display the same message for weeks or months at a time, electronic displays enable the message to be changed easily and often. Thus, it may be possible to modify the visual content many times in a single day. Furthermore, electronic displays may be networked together such that the displays may communicate with each other, or with a central computer.

With all these new capabilities enabled by a network of electronic displays, there is a need for systems and methods for scheduling and presenting visual content on electronic displays that are configured as part of a network of electronic displays. Furthermore, there is a need for enabling a user to view and select a variety of scheduling options for where and when the visual content may be displayed and enable the user to communicate the visual content to the electronic displays.

### BRIEF SUMMARY OF THE INVENTION

The present invention provides systems and methods for presenting media content on electronic displays that are configured as part of a network of electronic displays and enables a user to view and select a variety of scheduling options for where and when the media content may be displayed.

One embodiment of the present invention comprises a display network including a computing server, a plurality of electronic displays at a variety of display locations, and a graphical user interface configured for execution on the computing server. The electronic displays are configured for communication with the computing server. The graphical user interface includes a scheduling module configured for presenting a combination of display locations and display times to a user. This scheduling module is also configured for enabling the user to select from the graphical user interface at least one display time correlated to at least one electronic display for presentation of a media content on the at least one electronic display.

Another embodiment of the present invention comprises a method of scheduling media content on a display network including a plurality of electronic displays at a variety of display locations. The method includes enabling communication of a media content from a computing server to at least one electronic display and enabling execution of a graphical user interface on the computing server. The graphical user interface is configured to include a graphical representation of a combination of the electronic displays and display times. The method also includes enabling a user to select from the graphical user interface at least one display time correlated to at least one electronic display for presentation of the media content on the at least one electronic display.

Yet another embodiment of the present invention comprises a computer program product adaptable for storage on a computer readable medium and configured for execution by a computing device. The computer program product is configured to present to a user a graphical user interface including a schedule of times for a plurality of electronic displays at a variety of display locations. The computer program product is also configured to enable the user to select from the graphical user interface at least one display time correlated to at least one electronic display of the plurality for presentation of a media content on the at least one electronic display. The computer program product is also configured to communicate the media content from a computing server to the at least one electronic display and display the media content at the at least one electronic display at the at least one display time selected by the user.

Another embodiment of the present invention comprises a method of presenting media content on a display network. The method includes providing a computing server and providing a plurality of electronic displays at a variety of display locations and in communication with the computing server. The method further includes communicating a plurality of media contents to the computing server and communicating the at least one media content to the at least one electronic display. The method further includes enabling a user to access a graphical user interface on the computing server to view and plan a schedule of times for at least one media content of the plurality on at least one electronic display of the plurality. The method also includes displaying the at least one media content on the at least one electronic display at the schedule of times.

In all the embodiments, the media content may include visual content, audio content, and combinations thereof

### BRIEF DESCRIPTION OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a display network in accordance with a representative embodiment of the invention;

FIG. 2 is a block diagram of a representative software organization for managing aspects of the display network;

FIG. 3 is a representative graphical user interface that may be used for selecting a schedule of times for presenting media content on the display network;

FIG. 4 is another illustration of a representative graphical user interface that may be used for selecting a schedule of times for presenting media content on the display network;

FIG. 5 is a representative graphical user interface that may be used for illustrating scheduling details for the display network;

FIG. 6 is a representative graphical user interface that may be used for illustrating order details for the display network;

FIG. 7 is a representative graphical user interface that may be used for illustrating and modifying information about various electronic displays on the display network;

FIG. 8 is a representative graphical user interface that may be used for illustrating order details for various orders for the display network;

FIG. 9 is a representative graphical user interface that may be used for illustrating information about various customers of the display network; and

FIG. 10 is a representative graphical user interface that may be used for illustrating status details of various electronic displays on the display network.

### DETAILED DESCRIPTION OF THE INVENTION

The present invention provides systems and methods for presenting media content on electronic displays that are configured as part of a network of electronic displays and enables a user to view and select a variety of scheduling options for where and when the media content may be displayed.

In the following description, elements, circuits, and functions may be shown in block diagram form in order not to obscure the present invention in unnecessary detail. Conversely, specific implementations shown and described are exemplary only and should not be construed as the only way to implement the present invention unless specified otherwise herein. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

Furthermore, in this description of embodiments of the invention, reference is made to the accompanying drawings which form a part hereof, and in which is shown, by way of illustration, specific embodiments in which the invention may be practiced. The embodiments are intended to describe aspects of the invention in sufficient detail to enable those skilled in the art to practice the invention. Other embodiments may be utilized and changes may be made without departing from the scope of the present invention. The following detailed description is not to be taken in a limiting sense, and the scope of the present invention is defined only by the appended claims.

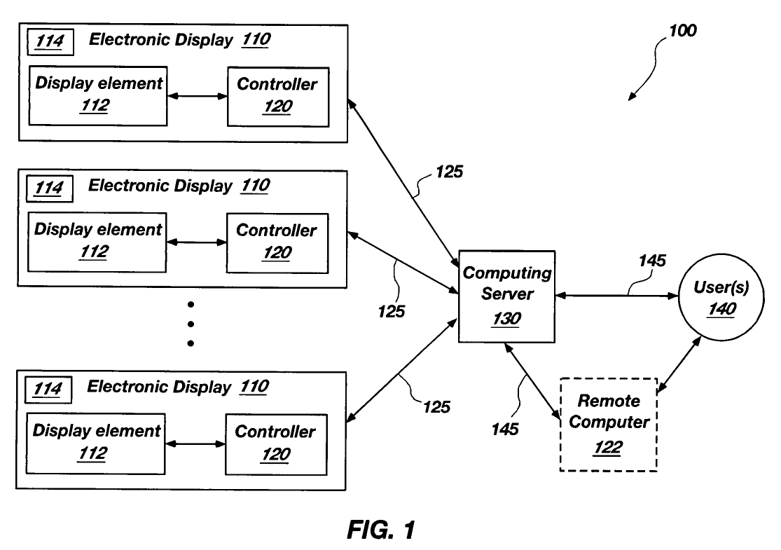

FIG. 1 illustrates a display network 100 in accordance with a representative embodiment of the invention. The display network 100 includes at least one electronic display 110, a computing server 130, and one or more users 140. The display network 100 may also include an optional remote computer 122 from which the user 140 may access the computing server 130.

In the display network 100, the electronic displays 110 may be located at different geographical locations. For example, the electronic displays 110 may be roadside billboards that are located at different locations within a city, or they may be located at different geographical locations across a country, or around the world.

Each electronic display 110 includes a display element 112, may include a controller 120, and may also include an audio element 114. Each electronic display 110 is capable of presenting visual content in the forms of text, still images, animations, video images, and may also be capable of presenting audio content. Furthermore, the visual content may include combinations of visual content in the form, text, still images, animations and video images in the form of adjacent portions of the display carrying different types of media content as well as overlays of different types of content on top of other types of content. In addition, the media content may include both visual content and audio content. In some embodiments including both video and audio, the audio content may be synchronized to video images or various aspects of still images and animations as are known by those of ordinary skill in the art.

Electronic displays may take on a number of forms and formats. By way of example, and not limitation, electronic displays may be in the form of billboards, displays on busses, displays on bus shelters, mall directory signs, airport signs, signs in sporting and other event arenas, signs on taxis, and any other place where displays are used by multiple advertisers.

The visual content may be formatted in any suitable format for presenting and transmitting video, still-images, and text. By way of example, and not limitation, some of the formats may include ASCII text, graphic interchange formats (GIF), bitmap (BMP) formats, Joint Photographic Experts Group (JPEG) formats, Moving Picture Experts Group (MPEG) formats, and the like. Similarly, the audio content may be formatted in any suitable format for presenting and transporting audio. By way of example, and not limitation, some of the formats may include MPEG-3 (MP3), wave (WAV) windows media audio (WMA), Advanced Audio Coding (AAC), and the like.

Each electronic display 110 may include a controller 120 for receiving and storing media content to be presented on that electronic display 110 at some scheduled time. The display elements 112 may be configured with lights, LEDS, Liquid Crystal Displays (LCDs), plasma displays, and the like. The controller 120 may include functions such as, for example, formatting the content for its electronic display 110, animating the content for its electronic display 110, controlling presentation of content on the display element 112, controlling presentation of audio content on the audio element 114, controlling timing of various content on the display element 112, controlling timing of various content on the audio element 112, and communicating with the computing server 130.

The computing server 130 is configured to control one or more electronic displays 110 and communicate with each electronic display 110 across a display communication link 125. The display communication link 125 may be any suitable communication link, such as, for example, any suitable direct-wired communication bus, satellite link, direct telephone line, wireless telephone link, or other wireless data links. The display communication link 125 may be intermittent or continuous. As a continuous communication example, with sufficient bandwidth a continuous communication link may be established to distribute media content as substantially real-time video directly to the electronic display 110. As an intermittent communication example, a communication link may be established between the electronic display 110 and the computing server 130 for short bursts of time to communicate information such as display status, media content, scheduling information, new software/firmware for the controller 120, and the like. Furthermore, the communication link may be initiated from either the electronic display 110 or the computing server 130.

In some embodiments, the electronic display 110 may not include a controller 120 and the computing server 130 may perform, among other things, those functions that would normally be performed by the controller 120. In other systems, the electronic display 110 may include a very simple controller 120 configured for communication and display control, leaving other functions to be performed by the computing server 130.

A user 140 may communicate with the computing server 130 across a user communication link 145. The user communication link 145 may be any link similar to those described for the electronic display communication link 125. In some embodiments, the communication server may be configured to enable user access through the internet via a web page, or similar interface via the remote computer 122. In addition, the user 140 may operate the computing server 130 directly, such as by keyboard, mouse, joystick, and the like. The user 140 may provide content to the computing server 130, for transmission to one or more of the electronic displays 110, in a number of ways. For example, a still or video camera may be connected directly to the computing server 130, text content may be entered from a keyboard, or any type of content (e.g., image, video, text, animation) may be supplied through the user communication link 145. In addition, content may be supplied to the computing server 130 on transportable media, such as for example, FLASH memory drive, magnetic tape, magnetic disc, or optical disc.

In some embodiments, the display network 100 may be configured for access by a user 140 that is in control of the network. In those embodiments, access to the computing server 130 may be limited to the controlling user or agents of the controlling user. For example, in many cases there may be a number of electronic displays 110 at a single location. A single premises or business location may include a large outdoor electronic billboard, it may include an electronic display 110 for viewing by foot traffic near the premises, and it may include electronic displays 110 at entrances to the business or at locations within the business. These electronic displays 110 may be controlled by the computing server 130 and access to the computing server 130 may be limited to the premises owner or an agent of the premises owner.

In other cases, there may be a number of electronic displays 110 at geographically diverse locations that are controlled by the computing server 130. In these cases, access to the computing server 130 may be limited to the controlling user or agents of the controlling user. However, access to the computing server 130 may also be opened up to other users 140, such as, for example, advertising customers to perform tasks on the computing server 130 such as submitting media content and scheduling times and locations for that media content, as is explained more fully below. In addition, access to the computing server 130 may also be opened up to a user 140 such as a government agency for display of media content such as emergency messages or traffic messages.

Turning to the software for the display network 100, those of ordinary skill in the art will recognize that the software processes illustrated herein are intended to illustrate representative processes that may be performed by embodiments of the present invention. Unless specified otherwise, the order in which the processes are described is not intended to be construed as a limitation. Furthermore, the processes may be implemented in any suitable hardware, software, firmware, or combinations thereof. By way of example, software processes may be configured for execution on the computing server 130, the controllers 120 associated with each electronic display 110, or combinations thereof. When executed as firmware or software, the instructions for performing the processes may be stored on a computer readable medium. A computer readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

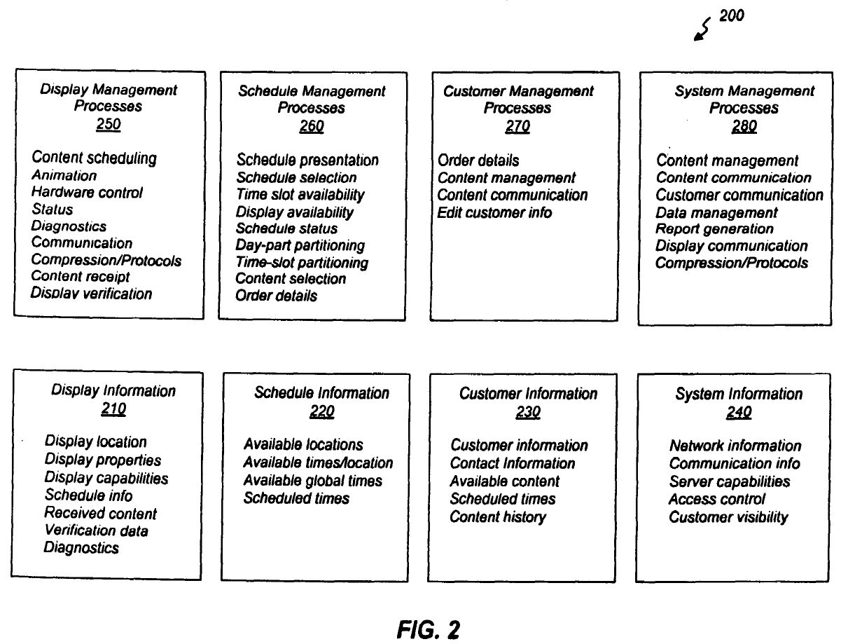

FIG. 2 is a block diagram of a representative software organization for managing aspects of the display network. The software (also referred to as a computer program product) for use in managing and controlling the display network may be generally described as information modules (e.g., databases) and process modules. Those of ordinary skill in the art will recognize that this organization is useful for description purposes but is somewhat arbitrary and some information and processes may overlap both the information modules and the process modules.

The information modules may be generally described as display information 210, schedule information 220, customer information 230, and system information 240. Of course, the partitioning of the databases is representative of a specific embodiment of the present invention. Other partitioning solutions, or no partitioning at all, may be used within the scope of the present invention.

By way of example, and not limitation, some information is listed to indicate the type of information that may be used in the display network. This listing is intended to be exemplary only, and not an exhaustive list of the information used or stored in the display network. The display information 210 may include: display location, display properties, display capabilities, schedule info, received content, verification data, and diagnostics. The schedule information 220 may include: available locations, available times/location, available global times, and scheduled times. The customer information 230 may include: customer information, contact information, available content, scheduled times, and content history. The system information 240 may include: network information, communication information, computing server capabilities, access control, and customer visibility.

Data in the information modules (210, 220, 230, and 240) may be concentrated in one location, for example at the computing server, or at a specific electronic display. However, the data may also be distributed such that some information is located at the electronic display, some information is at the server, and some information is duplicated in multiple places.

The process modules may be generally described as display management processes 250, schedule management processes 260, customer management processes 270, and system management processes 280. As with the databases, the partitioning of the processes is representative of a specific embodiment of the present invention. Other partitioning solutions, or no partitioning at all, may be used within the scope of the present invention. Similarly, each process may draw from information from any or all of the information modules (210, 220, 230, and 240) as well as information or results from other process modules (250, 260, 270, and 280).

By way of example, and not limitation, some processes are listed to indicate the type of processes that may be performed by the display network. This listing is intended to be exemplary only, and not an exhaustive list of the processes performed by the display network. The display management processes 250 may include: content scheduling, animation, hardware control, status, diagnostics, communication, compression algorithms, communication protocols, content receipt, display verification. The schedule management processes 260 may include: schedule presentation, schedule selection, time slot availability, display availability, schedule status, day-part partitioning, time slot partitioning, content selection, and order details. The customer management processes 270 may include: order details, content management, content communication, and customer information editing processes. The system management processes 280 may include: content management, content communication, customer communication, data management, report generation, display communication, compression algorithms, and communication protocols.

Execution of process modules (250, 260, 270, and 280) may be concentrated in one location, for example at the computing server, or at a specific electronic display. However, the execution may also be distributed such that some of the process is executed at the electronic display some of the process is executed at the server, some of the process is executed at the remote computer, and combinations thereof.

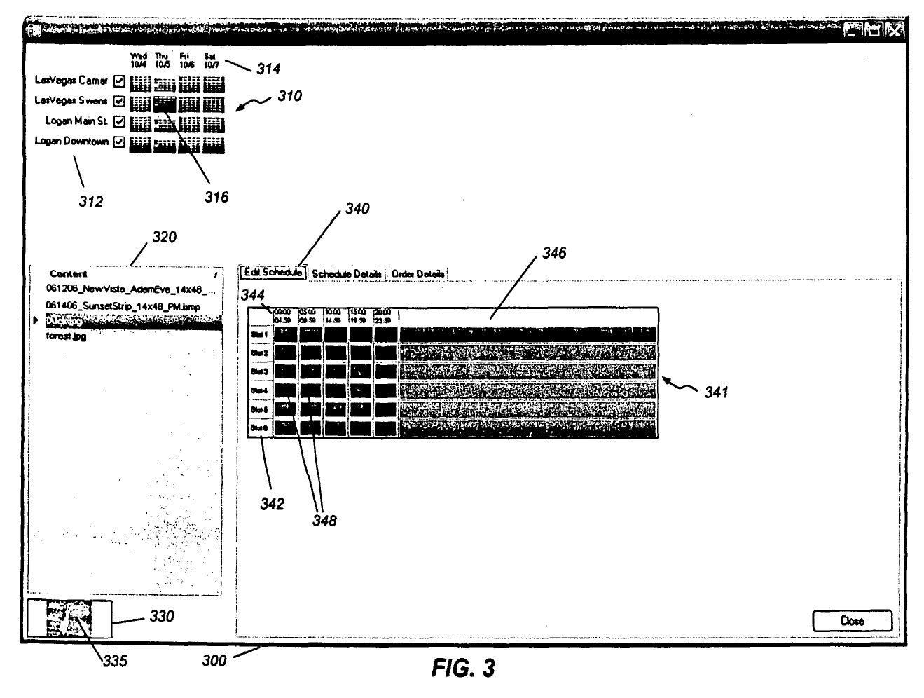

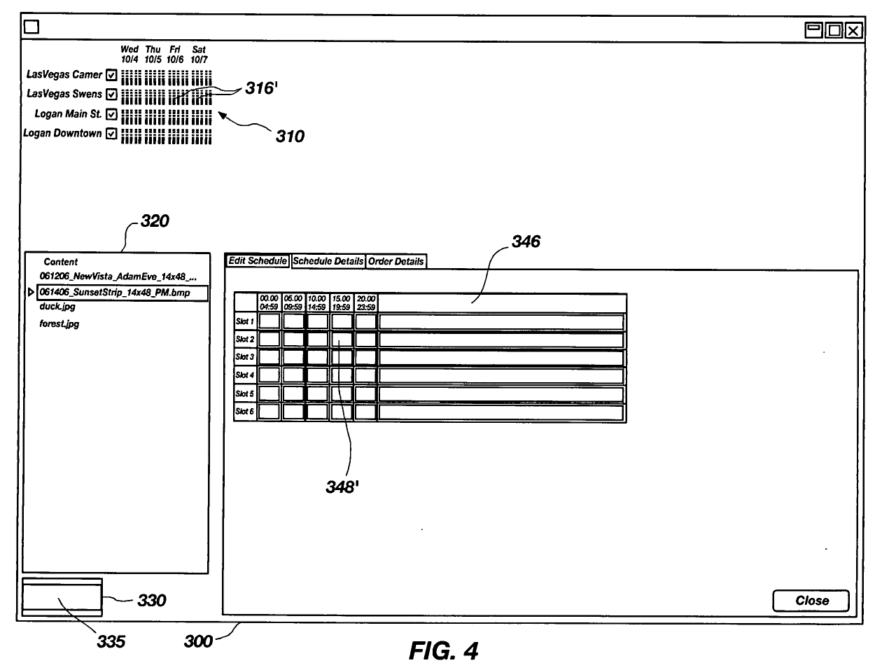

Operation of specific processes and use of specific information will be described with respect to FIGS. 3-10. FIGS. 3 and 4 illustrate a representative graphical user interface 300 that may be used for selecting a schedule of times for presentation of media content on the display network. The embodiment of FIGS. 3 and 4 includes a schedule summary view 310, a content summary view 320, a content preview area 330, and a schedule-editing interface 340. Within the content summary view 320, display identifiers 312 for each electronic display in the display network are listed as rows of a matrix. Similarly, schedule identifiers for specific days are listed as columns of a matrix. The specific days may be days in the past such that the schedule summary view 310 indicates content that has been previously displayed, or may be days in the present or future to indicate times and electronic displays that may be available for scheduling. Thus, the summary view includes multiple matrix elements wherein each element indicates a specific day for a specific electronic display.

Within each matrix element, a sub-matrix is displayed. This sub-matrix illustrates various scheduling options within the specific day represented by the scheduling options that are selected using the schedule-editing interface 340 as will be described more fully below.

The content summary view 320 is a listing of media content that is currently on the computing server and available for scheduling. A user may select any of the listed content. The selected content will be displayed in the content preview area 330 and is available for scheduling through the schedule-editing interface 340.

The schedule-editing interface 340 provides a mechanism for selecting specific times when selected content should be displayed on the electronic display. A daily matrix 341 (also referred to as a day-part summary view) is organized as columns of time segments (also referred to as day-parts 344) for which media content may be scheduled. Rows of the daily matrix 341 define time slots 342 that are available within each day-part 344. Column 346 indicates what content is currently scheduled in a selected daily matrix element 348.

Within the daily matrix 341, the day is segmented into one or more day-parts 344. In the representative embodiments illustrated herein, the day is segmented into four five-hour day-parts 344 and one four-hour day-part 344. Of course, the day-parts 344 may be segmented in many different ways, or not segmented at all such that there is only one day-part 344. Furthermore, the day-parts 344 may be of different lengths. For example, for a network of roadside billboards, the owner or controller of the display network may wish to include shorter day-parts 344 during rush hour when traffic is at a peak and the time slots 342 may be sold for a premium. Conversely, a long day-part 344 may be defined for the evening to early morning hours, when traffic is light.

Each day-part 344 is segmented into one or more time slots 342. In FIGS. 3 and 4, six time slots 342 are illustrated. The duration of presentation of a specific media content may be configured as a specific length of time. As an example, perhaps the duration is set at 15 seconds. In that case, at the start time of a day-part, the media content scheduled for time slot 1 will be displayed for 15 seconds. Next, the media content scheduled for time slot 2 will be displayed for 15 seconds. This continues up through the last time slot. After the media content for the last time slot is displayed, the electronic display cycles back to displaying the media content in time slot 1. This cycling continues throughout the current day-part 344.

In operation, to schedule content the user would find the particular media content that the user was interested in scheduling in the content summary view 320. The user would also select one or more specific matrix elements from the content preview area 330 to select one or more electronic displays and one or more scheduling days. For example, FIG. 3 illustrates that matrix element 316 has been selected, indicating that a schedule editing process may be performed for the electronic display “LasVegasSwens” for the date “Thu 10/5.” Similarly, FIG. 4 illustrates that matrix elements 316′ have been selected, indicating that a schedule editing process may be performed for the electronic display “LasVegasSwens” for the dates “Fri 10/6 and Sat 10/7.” Any other combinations of selection are possible. For example, the user may select “Logan Downtown” for “Wed 10/4” in combination with “LasVegasCamer” for “Thu 10/5” and “Fri 10/6.”

With the specific media content, electronic displays, and dates selected, the user can use the schedule-editing interface 340 to select specific day-parts 344 and specific time slots 342 within those day-parts. For example, in FIG. 3 the user has selected electronic display “LasVegasSwens” on “Thu 10/5” and the media content “duck.jpg.” The content preview area 330 illustrates a visual representation 335 of the selected content. The user has also selected time slot 1 for every day-part and column 346 indicates that the media content currently scheduled for the selected time slots is “duck.jpg.”

As another example, in FIG. 4 the user has selected display “LasVegasSwens” on “Fri 10/6” and “Sat 10/7” and the media content “061406_SunsetStrip_{—}14×18_PM.bmp.” The content preview area 330 illustrates a visual representation 335 of the selected content. The user has also selected matrix element 348′ comprising time slot 3 for the day-part between 3 and 6 PM. Column 346 indicates the media content currently scheduled for the selected time slot.

Those of ordinary skill in the art will recognize that a scheduling module may be presented graphically in a number of ways within the scope of the present invention. As examples, the display times and available electronic displays may be shown in a different type of matrix configuration or illustrated in some type of linear fashion rather than a matrix fashion. Furthermore, the GUI 300 may be configured such that the user selects specific times, which then enables presentation of electronic displays that are available at those selected times. Similarly, the GUI 300 may be configured such that the user selects specific electronic displays, which then enables display of times that are available for those selected electronic displays.

In addition, as illustrated in FIG. 3, the schedule summary view 310 may illustrate scheduled time slots as un-shaded matrix elements and available time slots as shaded matrix elements. Thus, the user can readily identify that time slot 1 is scheduled on all the electronic display devices for all the day-parts of Thursday 10/5. In addition, time slot 4 is scheduled on all the electronic display devices for the first day-part of Thursday 10/5. Of course, the visual indicator may be in many forms other than shading, for example, a color such as red may be used to indicate a scheduled time slot and a color such as green may be used to indicate an available time slot. In addition, icons may be used rather shading or colors.

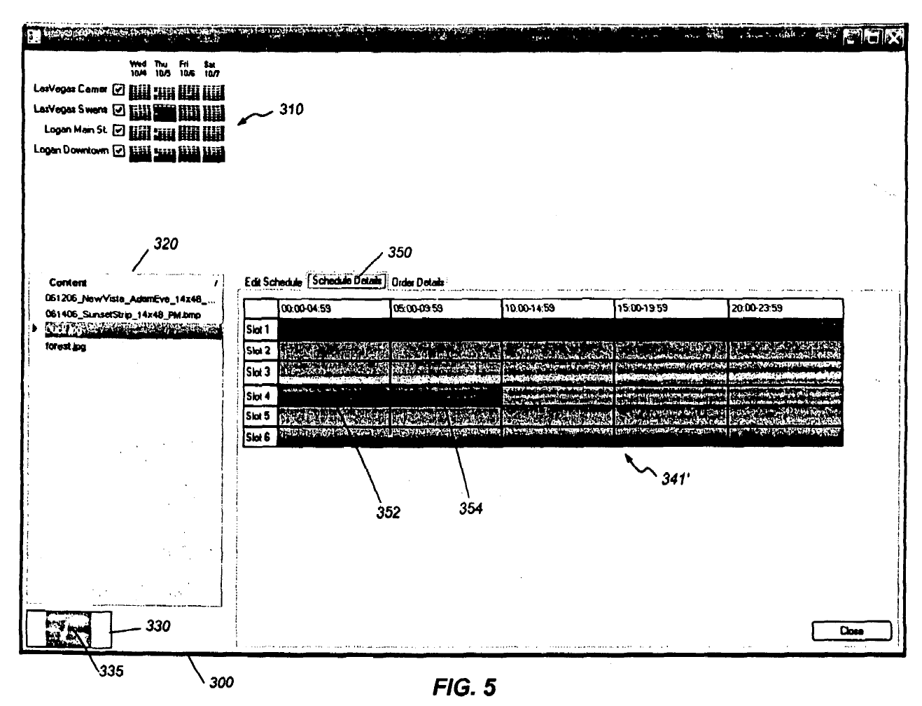

FIG. 5 is a representative GUI 300 that may be used for illustrating scheduling details for the display network. The schedule detail interface 350 is similar to the schedule-editing interface 340 in that it includes the schedule summary view 310, the content summary view 320, the content preview area 330, and a daily matrix 341′. However, the daily matrix 341′ is somewhat different in that each element that is represented by a specific day-part and a specific time slot contains the file identifier for the media content that is scheduled. With this view, the user is able to see that for time slot 4 during the first day-part, matrix element 352 indicates that “duck.jpg” is scheduled and for time slot 4 during the second day-part, matrix element 354 indicates that “forest.jpg” is scheduled.

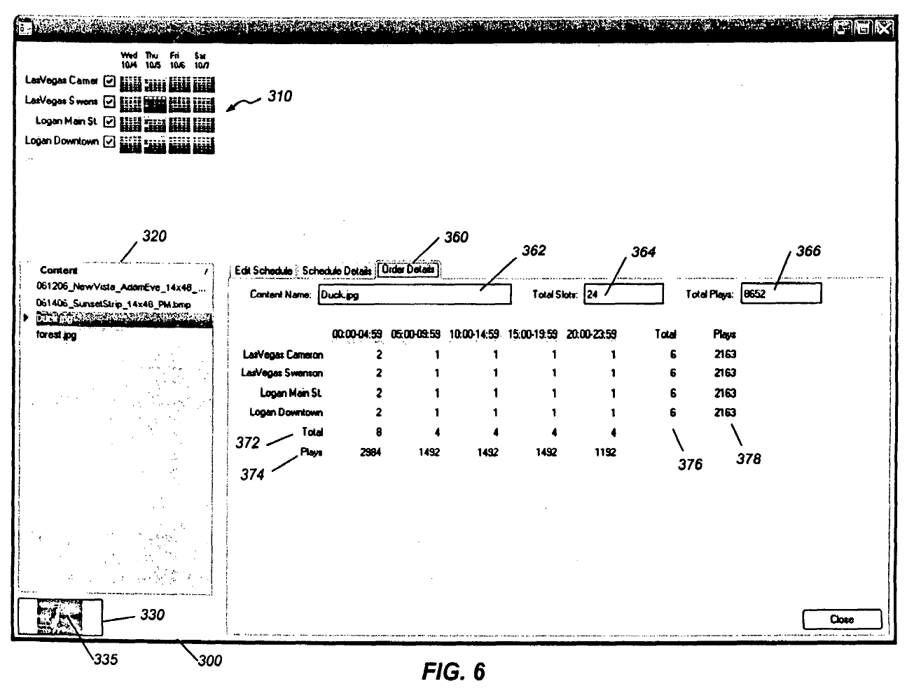

FIG. 6 is a representative GUI 300 that may be used for illustrating order details for the display network. The order detail interface 360 is similar to the schedule-editing interface 340 in that it includes the schedule summary view 310, the content summary view 320, and the content preview area 330. The order detail area 360 illustrates information about when and where the selected content will be displayed or has been displayed. As the example of FIG. 6 illustrates, the user selects a specific day in the schedule summary view 310 and selects the media content in the content summary view 320. The order detail interface 360 shows a file identifier for the selected content 362, the total time slots scheduled 364 and the total number of plays scheduled 366. The order detail interface 360 also shows total time slots scheduled for each day-part 372, total number of plays for each day-part 374, total number of time slots for each display 376 and total number of plays for each display 378.

Thus, for the day selected, FIG. 6 illustrates that on Thursday, 10/5 the electronic display located at Logan Downtown is scheduled for six time slots and a total of 2163 plays of the media content duck.jpg. FIG. 6 also illustrates that for the first day-part of Thursday, 10/5 there are a total of eight time slots and 2984 plays scheduled for presentation of the media content duck.jpg across all of the display network.

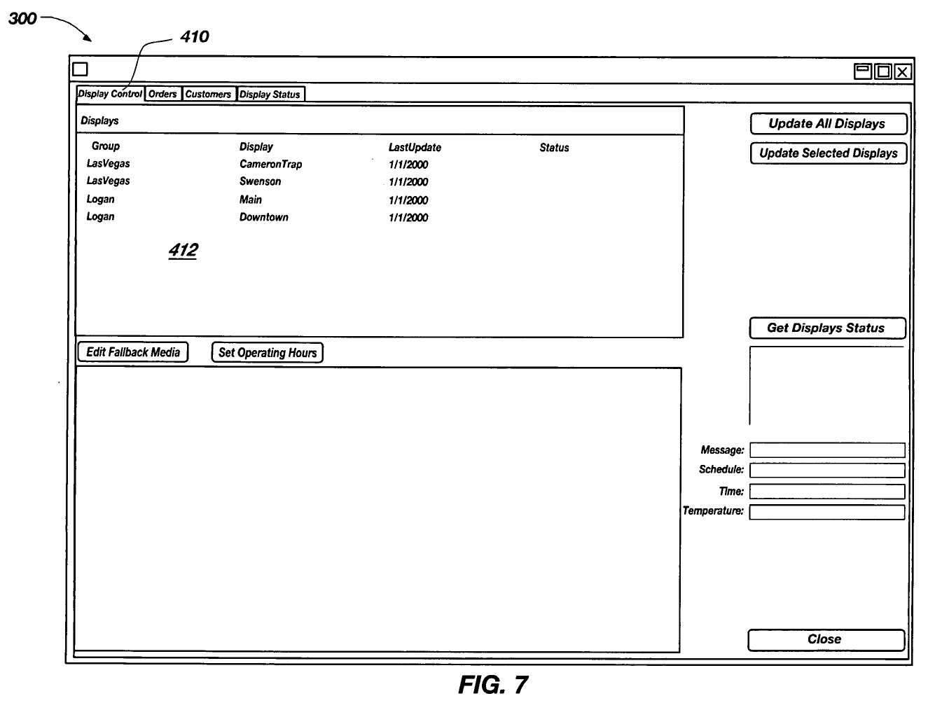

FIG. 7 is a representative GUI 300 that may be used for illustrating and modifying information about various electronic displays on the display network. The display control interface 410 may include features such as, a window 412 to illustrate all electronic displays on the display network, and indicators of whether the displays are configured as belonging to a certain group of electronic displays. By way of example, and not limitation, some controls may be: a control to set a fallback media for the selected display if nothing is scheduled for a time slot, a control for setting operating hours of the selected display, a control to get the current status of the selected display, a control to update selected displays, and a control to update all displays on the network. Updating the displays may include operations, such as, for example, transmitting media content to the displays, transmitting schedule information to the displays, transmitting configuration information to the displays, and receiving status information from the displays.

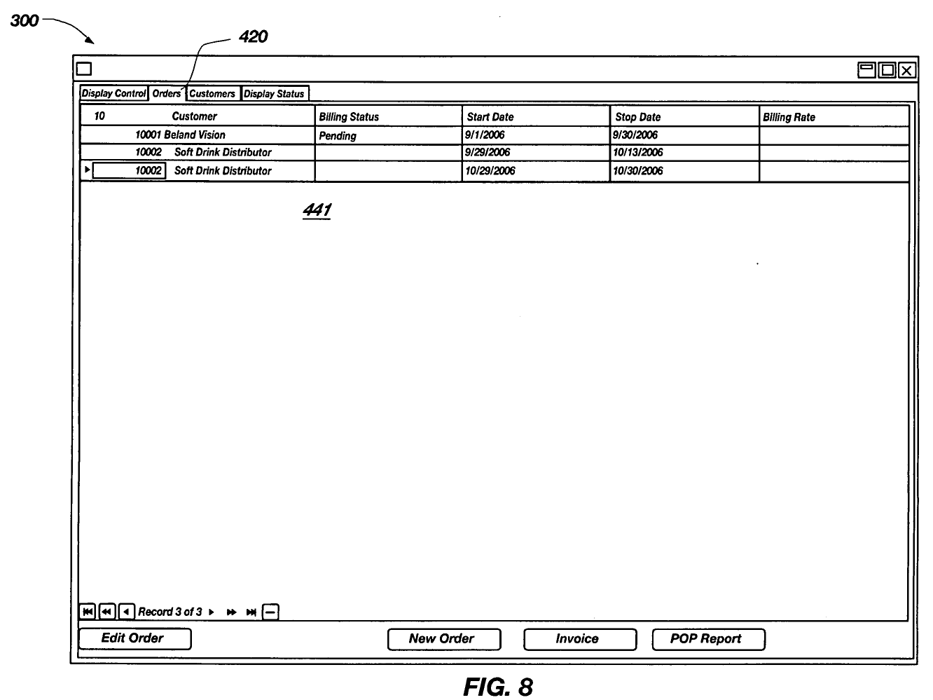

FIG. 8 is a representative GUI 300 that may be used for illustrating order details for various orders for the display network. The customer order interface 420 may include information about the various orders that have been presented or will be presented on the display network. By way of example, and not limitation, this customer order interface 420 may include a variety of information about the customers and their orders such as name, identification number, billing status, billing rates, start date for the order, and stop date for the order.

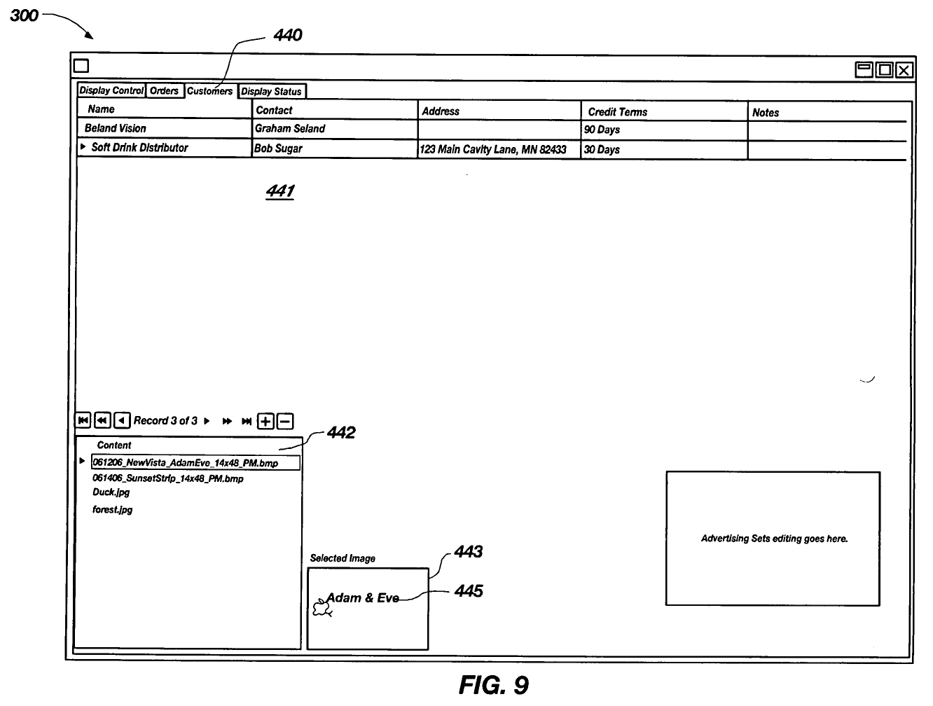

FIG. 9 is a representative GUI 300 that may be used for illustrating information about various customers of the display network. The customer data interface 440 may include information about the various customers that have presented or will be presenting media content on the display network. By way of example, and not limitation, this customer data interface 440 may include a variety of information about the customers and their orders such as: name, contact information, and credit terms. A user can select a customer from a customer listing area 441. The customer data interface 440 may also include a content summary view 442 that lists all content stored on the display network belonging to the selected customer. A user can select a specific media content from content summary view 442 and see a representation of the selected media content 445 in a content preview area 443.

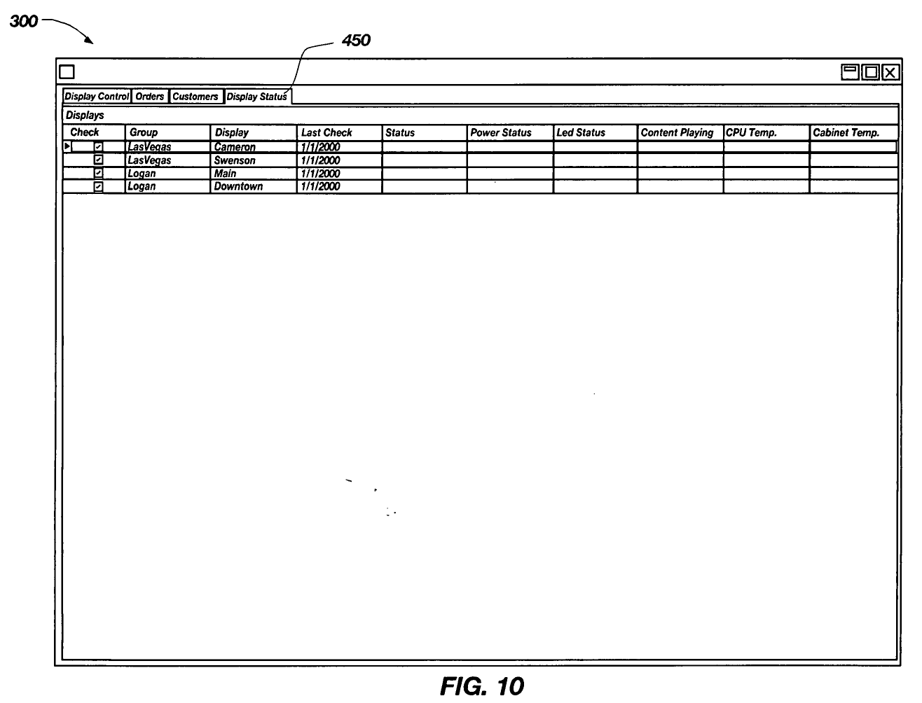

FIG. 10 is a representative GUI 300 that may be used for illustrating status details of various electronic displays on the display network. A display status interface 450 may list all the displays on the display network and give status of the displays. By way of example, and not limitation, some of the status information may include items such as, display name, group to which the display belongs, last time status was checked, general status, power status, display element (e.g. LED) status, content currently displayed, CPU temperature, cabinet temperature, results of diagnostic tests, and the like.

Although this invention has been described with reference to particular embodiments, the invention is not limited to these described embodiments. Rather, the invention is limited only by the appended claims, which include within their scope all equivalent devices or methods that operate according to the principles of the invention as described.

1. A display network, comprising:
a computing server;
a plurality of electronic displays at a variety of display locations and configured for communication with the computing server; and
a graphical user interface configured for execution on the computing server and including a scheduling module configured for presenting a combination of display locations and display times to a user, the scheduling module further configured for enabling the user to select from the graphical user interface at least one display time correlated to at least one electronic display for presentation of a media content on the at least one electronic display.

2. The display network of claim 1, wherein each of the plurality of electronic displays is configured for receiving scheduling information from the computing server and receiving the media content from the computing server.

3. The display network of claim 2, wherein the computing server is configured for communication to receive the media content from the user and transmit the media content to the at least one electronic display.

4. The display network of claim 1, wherein the graphical user interface is configured for operation at a remote computer in communication with the computing server over the internet.

5. The display network of claim 1, wherein the media content is selected from the group consisting of visual content, audio content, and combinations thereof.

6. The display network of claim 1, wherein the media content is selected from the group consisting of text messages, still images, animations, video, and combinations thereof.

7. The display network of claim 1, wherein the user is selected from the group consisting of a display network operator, an agent of the display network operator, an advertising customer, a government agency, and combinations thereof.

8. The display network of claim 1, wherein each electronic display of the plurality of electronic displays is selected from the group consisting of billboards, displays on busses, displays on bus shelters, mall directory signs, airport signs, signs in sporting and other event arenas, signs on taxis, and other places where displays are used by multiple advertisers.

9. The display network of claim 1, wherein the scheduling module further comprises a schedule summary view configured for enabling the user to select combinations of at least one day for the at least one display time and the at least one electronic display.

10. The display network of claim 9, wherein the scheduling module further comprises a day-part summary view configured for enabling the user to select at least one day-part within the at least one day and at least one time slot within the at least one day-part.

11. A method of scheduling media content on a display network including a plurality of electronic displays at a variety of display locations, comprising;
enabling communication of a media content from a computing server to at least one electronic display of the plurality;
enabling execution of a graphical user interface on the computing server, the graphical user interface including a graphical representation of a combination of the plurality of electronic displays and display times; and
enabling a user to select from the graphical user interface at least one display time correlated to at least one electronic display for presentation of the media content on the at least one electronic display.

12. The method of claim 11, further comprising enabling communication of the media content to the computing server.

13. The method of claim 11, wherein the graphical user interface is configured operation at a remote computer in communication with the computing server over the internet.

14. The method of claim 11, wherein the media content is selected from the group consisting of visual content, audio content, and combinations thereof.

15. The method of claim 11, wherein the media content is selected from the group consisting of text messages, still images, animations, video, and combinations thereof.

16. The method of claim 11, wherein the user is selected from the group consisting of a display network operator, an agent of the display network operator, an advertising customer, a government agency, and combinations thereof.

17. The method of claim 11, wherein each electronic display of the plurality of electronic displays is selected from the group consisting of billboards, displays on busses, displays on bus shelters, mall directory signs, airport signs, signs in sporting and other event arenas, signs on taxis, and other places where displays are used by multiple advertisers.

18. The method of claim 11, further comprising enabling the user to select combinations of at least one day for the at least one display time and the at least one electronic display.

19. The method of claim 18, further comprising enabling the user to select at least one day-part within the at least one day and at least one time slot within the at least one day-part.

20. A computer program product adaptable for storage on a computer readable medium and configured for execution by a computing device, to perform the acts of:
presenting to a user a graphical user interface including a schedule of times for a plurality of electronic displays at a variety of display locations;
enabling the user to select from the graphical user interface at least one display time correlated to at least one electronic display of the plurality for presentation of a media content on the at least one electronic display;
communicating the media content from a computing server to the at least one electronic display; and
displaying the media content at the at least one electronic display at the at least one display time selected by the user.

21. The computer program product of claim 20, wherein the computer program product is configured for operation on a computing device selected from the group consisting of the computing server, the at least one electronic display, a remote computer, and combinations thereof.

22. The computer program product of claim 20, further comprising enabling communication of the media content from a remote computer to the computing server.

23. The computer program product of claim 20, wherein the graphical user interface is configured for operation at a remote computer in communication with the computing server over the internet.

24. The computer program product of claim 20, wherein the media content is selected from the group consisting of visual content, audio content, and combinations thereof.

25. The computer program product of claim 20, wherein the media content is selected from the group consisting of text messages, still images, animations, video, and combinations thereof.

26. The computer program product of claim 20, wherein the user is selected from the group consisting of a display network operator, an agent of the display network operator, an advertising customer, a government agency, and combinations thereof.

27. The computer program product of claim 20, wherein each electronic display of the plurality of electronic displays is selected from the group consisting of billboards, displays on busses, displays on bus shelters, mall directory signs, airport signs, signs in sporting and other event arenas, signs on taxis, and other places where displays are used by multiple advertisers.

28. The computer program product of claim 20, further comprising enabling the user to select combinations of at least one day for the at least one display time and the at least one electronic display.

29. The computer program product of claim 28, further comprising enabling the user to select at least one day-part within the at least one day and at least one time slot within the at least one day-part.

30. A method of presenting media content on a display network, comprising:
providing a computing server;
providing a plurality of electronic displays at a variety of display locations and in communication with the computing server;
communicating a plurality of media contents to the computing server;
enabling a user to access a graphical user interface on the computing server to view and plan a schedule of times for at least one media content of the plurality on at least one electronic display of the plurality;
communicating the at least one media content to the at least one electronic display; and
displaying the at least one media content on the at least one electronic display at the schedule of times.

31. The method of claim 30, wherein the graphical user interface is configured for operation at a remote computer in communication with the computing server over the internet.

32. The method of claim 30, wherein the media content is selected from the group consisting of visual content, audio content, and combinations thereof.

33. The method of claim 30, wherein the media content is selected from the group consisting of text messages, still images, animations, video, and combinations thereof.

34. The method of claim 30, wherein the user is selected from the group consisting of a display network operator, an agent of the display network operator, an advertising customer, a government agency, and combinations thereof.

35. The method of claim 30, wherein each electronic display of the plurality of electronic displays is selected from the group consisting of billboards, displays on busses, displays on bus shelters, mall directory signs, airport signs, signs in sporting and other event arenas, signs on taxis, and other places where displays are used by multiple advertisers.

36. The method of claim 30, further comprising enabling the user to select combinations of at least one day for the at least one display time and the at least one electronic display.

37. The method of claim 36, further comprising enabling the user to select at least one day-part within the at least one day and at least one time slot within the at least one day-part.
